(19) United States
(12) Patent Application Publication
(10) Pub. No.: US 2020/0262662 A1
(43) Pub. Date: Aug. 20, 2020

(54) DOCK BUMPER

(71) Applicant: Süddeutsche Gelenkscheibenfabrik GmbH & Co. KG, Waldkraiburg (DE)

(72) Inventors: Armin Huber, Schoenberg (DE); Christian Rauch, Altenmarkt (DE); Martin Ebenhofer, Reut (DE)

(73) Assignee: Süddeutsche Gelenkscheibenfabrik GmbH & Co. KG, Waldkraiburg (DE)

(21) Appl. No.: 16/646,562

(22) PCT Filed: Sep. 11, 2018
(86) PCT No.: PCT/EP2018/074405

§ 371 Date: Mar. 11, 2020

(30) Foreign Application Priority Data
Sep. 11, 2017 (DE) 10 2017 008 542.0

(51) Int. Cl. B65G 69/00; F16F 1/377; F16F 1/44

(52) U.S. Cl. CPC B65G 69/001; F16F 1/377; F16F 2232/08; F16F 2224/025; F16F 2230/0029; F16F 1/44

(57) ABSTRACT

A dock bumper is provided for attaching to a building, the dock bumper comprising at least one fixation system for fixing the dock bumper, at least one elastic body connected to the at least one fixation system, and at least one impact system for transmitting to the elastic body the impact forces arising from the impact of the vehicle.

The present invention relates to a dock bumper for attachment to a building with a loading ramp, a loading bay, a dock leveller or similar.

Dock bumpers of this kind are attached to a building in the area of the loading ramp etc. To load and unload, the vehicles, in particular trucks, reverse to the loading ramp. To minimise the distance between the truck bed of the vehicle and the loading ramp, the vehicles are brought closer to the loading ramp until contact exists between the vehicle, which can likewise have a bumper, and the dock bumper. The dock bumper prevents damage to the vehicle and the building when the vehicle drives against the dock bumper.

Various dock bumpers are known from the prior art. The document DE 103 58 041 B3 discloses a dock bumper for mounting on a loading ramp. The dock bumper according to this document has a first U-shaped part, a second U-shaped part and an elastic damping element. The limbs of the second U-shaped part are arranged adjacent and movably relative to the limbs of the first U-shaped part. The elastic damping element is arranged inside the U-shaped parts. Document DE 103 13 268 A1 discloses a dock bumper which has a mounting frame and a buffer block. The height of the buffer block is adjustable by means of a linear drive such as a piston-cylinder unit, for example.

An object of the present invention is to provide a dock bumper that has an increased service life with a simple structure.

This object is achieved by a dock bumper with the features of claim 1.

Other embodiments are indicated in the dependent claims.

The dock bumper according to the invention comprises at least one attachment fixture for attaching the dock bumper to a building, at least one elastic body connected to the at least one attachment fixture, and at least one impact fixture for transmitting the impact forces arising on impact of a vehicle to the elastic body. The at least one elastic body has an elastically deformable structure, which is designed so that the impact fixture is deflectable with elastic deformation of the elastically deformable structure relative to the attachment fixture.

The dock bumper according to the invention can absorb relative movements between the attachment fixture and the impact fixture with the elastically deformable structure of the elastic body. Relative movements between the attachment fixture and the impact fixture can occur if the impact fixture of the dock bumper comes into contact with a vehicle or is in contact with it. In this state the level or height of the vehicle, for example, can be adjusted to the height of the loading ramp. Furthermore, the level of the vehicle can change when loading and unloading. During loading the level of the vehicle can be lowered by compression of the vehicle suspension. During unloading the level of the vehicle can be raised by decompression of the vehicle suspension. The dock bumper according to the invention can absorb such changes in the level of the vehicle with elastic deformation of the elastically deformable structure that is activated by a relative movement between the impact fixture in contact with the vehicle and the stationary attachment fixture mounted on the building. Damage to the dock bumper can be prevented by this and the service life thus increased.

In the event of large vertical movements and thus strong elastic deformation of the elastically deformable structure, the thickness of the dock bumper according to the invention is reduced due to the deflection of the impact fixture relative to the attachment fixture, due to which the impact force or pressing force exerted by the vehicle on the dock bumper is reduced. Due to the reduction of the impact force or pressing force, the static friction between the dock bumper and the vehicle is also reduced, whereby in the event of further relative movement the impact fixture of the dock bumper and the section of the vehicle in contact with the dock bumper can slide off one another. In other words, by reducing the thickness of the dock bumper and of the elastic body and the resultant sliding of the impact fixture on the vehicle, the elastic deformation of the elastically deformable structure can be limited after a predetermined path. Overload damage to the dock bumper in the event of excessive relative movements can be prevented thereby, due to which the service life is likewise increased. The dock bumper according to the invention thus provides a type of “self-protective effect”.

The elastically deformable structure can be designed so that the impact fixture is deflectable with elastic deformation relative to the attachment fixture in a direction which runs perpendicular to a plane spanned by two directions in which the elastic body can absorb relative movements of the impact fixture relative to the attachment fixture.

The elastically deformable structure of the elastic body can have at least one web. In a relative movement in a vertical direction between the impact fixture and the attachment fixture, the at least one web can be elastically deflected. The elastically deformable structure can have a plurality of webs, which extend substantially parallel to one another in the elastic body. The webs extend in the area between the impact fixture and the attachment fixture. The at least one web can provide a reset force that can move the elastically deformable structure back into its starting position again following loading.

The at least one web can be formed by at least one recess in the elastic body. Several recesses can be provided in the elastic body to form the webs. The width and the length of the webs can be determined by way of the recesses. The recesses can extend through the elastic body over the entire cross section of the elastic body.

The at least one web can extend perpendicular to the attachment fixture and the impact fixture. The at least one web can extend substantially parallel to the line of action of a force acting on the impact fixture in the event of an impact of a vehicle. If a force acts on the dock bumper in a direction parallel to the webs, the dock bumper or the elastic body is relatively stiff. If the loading of the dock bumper takes place in another direction, the impact fixture can be deflected, i.e. in this direction the dock bumper or the elastic body is relatively soft. In the event of a deflection of the impact fixture relative to the attachment fixture, the webs can extend obliquely to the attachment fixture. Due to this inclined position of the webs the thickness of the dock bumper can be reduced, whereby the static friction between the impact fixture and the vehicle can be reduced.

The at least one impact fixture can extend substantially along the entire elastically deformable structure. The at least one impact fixture can introduce the impact force into the elastically deformable structure of the elastic body and distribute it over the entire cross section of the elastically deformable structure. Due to this the section of a vehicle in contact with the impact fixture cannot penetrate locally or at points into the dock bumper. On account of the distribution of the force over the entire cross section of the elastically deformable structure by means of the impact fixture, the dock bumper can be relatively stiff in a direction parallel to the force acting on the dock bumper.

The at least one impact fixture can have at least one plate-shaped impact element. The plate-shaped impact element can extend substantially over the entire cross section of the elastically deformable structure. The plate-shaped impact element can distribute the impact force over the entire cross section of the elastically deformable structure and introduce it into the elastically deformable structure. The at least one impact fixture can have an elastic coating. The elastic coating can come into contact with a vehicle when the vehicle drives against the dock bumper. The elastic coating can extend along the plate-shaped impact element. The elastic coating is provided on the side of the impact fixture facing away from the elastic body. The elastic coating can have a predetermined thickness. For example, the elastic coating can have a thickness of roughly 1 cm. The elastic coating can be connected to the elastic body. The elastic coating can be executed in one piece with the elastic body. The elastic coating can also be formed separately from the elastic body, however, and extend exclusively along the plate-shaped impact element. The elastic coating can also be interchangeable. The elastic coating can be connected removably, for example, to the at least one plate-shaped impact element, so as to be able to be exchanged in the event of strong wear or damage to the elastic coating. It is also conceivable, however, not to provide any elastic coating on the impact fixture. In this case the surface of the dock bumper can be formed by the plate-shaped impact element, for example.

The attachment fixture can have at least one plate-shaped attachment element. The plate-shaped attachment element can be connected to a building, in order to attach the dock bumper to the building in the area of the loading ramp. The dock bumper can have at least one attachment opening, which extends through the at least one impact fixture, the at least one elastic body and the at least one attachment fixture. Expressed another way, the attachment openings extend fully through the dock bumper and thus through all parts of the dock bumper. The attachment opening in the attachment fixture can have a step at which its diameter is reduced.

The attachment fixture can have at least one attachment bush, which is received in the at least one attachment opening in the attachment fixture. The attachment bush can rest with its end section on the step of the attachment opening in the attachment fixture. The attachment bush can have a radial section and a tubular section. An opening can be formed in the radial section. Attachment means via which the dock bumper can be connected to a building wall can be led through this opening. The attachment means can be introduced via the attachment openings into the dock bumper and brought into contact with the attachment bush. The attachment means can rest with their head on the radial section of the attachment bush. A suitable tool for the attachment means can likewise be introduced through the attachment openings to be able to connect the attachment means to the building wall.

The at least one elastic body can be composed of several elastic body segments. The elastic body segments can each have an elastically deformable structure. The elastic body segments can accordingly each have at least one web and at least one recess. The elastic body segments can be arranged so that their webs and recesses are in alignment. A dock bumper can have an elastic body, for example, which is composed of four elastic body segments. The body segments can abut one another and yet not be connected directly to one another. Each elastic body segment can have two plate-shaped elements, which are used for connection to the impact plate and the attachment plate. The plates of the elastic body segments can have openings which can be connected to the impact fixture and the attachment fixture. In this case the impact fixture and the attachment fixture likewise have openings. The elastic body segments can thus be connected to one another via the impact fixture and the attachment fixture, so that a compact dock bumper is formed. After the impact fixture has been connected to the body segments, the impact fixture is provided with the elastic coating. The dock bumper can also be executed without elastic coating on the impact fixture. In this case the surface of the dock bumper can be formed by the plate-shaped impact element.

The at least one elastic body can be manufactured from a rubber such as an elastomer, for example. The elastic body can further be manufactured from a thermoplastic elastomer or a thermoplastic polyurethane, for example. The elastic coating can likewise be manufactured from these materials. The at least one plate-shaped impact element can be manufactured from metal. The plate-shaped impact element can preferably be manufactured from steel, aluminium or an aluminium alloy. The at least one attachment plate can likewise be manufactured from a metal. The elastically deformable structure can have at least one web, which has at least one thickening. In other words, the at least one web can be formed bulbously. The at least one thickening can be located in a central area of the at least one web. In the direction of the ends of the at least one web, the cross section of the at least one web can decrease starting out from the at least one thickening. Due to the at least one thickening of the at least one web, bending of the at least one web can be prevented, i.e. the web is stiffened by the thickening in its central area. Due to the thicker cross section of the at least one web in its central area, at least one of the end areas of the at least one web can form an articulation, as the at least one web has a thinner or reduced cross section (compared with the thickening) in one or both end areas. Due to the articulation at one or both of the end areas of the at least one web, the web can be deflected as a whole in the area of the articulation without bending in its central area.

The at least one elastically deformable structure can have several webs. The elastically deformable structure can have at least one web without thickening and at least one web with a thickening. The at least one web with at least one thickening can be arranged in a longitudinal direction at an end area of the elastically deformable structure. Furthermore, at least one web with at least one thickening can be provided at both end areas of the at least one elastically deformable structure. Between the webs with the at least one thickening there can be provided at least one web without a thickening. Several webs with a thickening can be provided. The webs with a thickening can be formed in groups on the elastically deformable structure. One group of webs with a thickening can be arranged respectively in the longitudinal direction of the dock bumper at each end area of the dock bumper.

In the resting state or unloaded state of the dock bumper, the at least one web can extend at a predetermined angle to the at least one attachment fixture. The predetermined angle can be 90°. In the unloaded state of the dock bumper the predetermined angle can also be unequal to 90°, however. The elastically deformable structure can comprise at least one web that extends at an angle of substantially 90° to the at least one attachment fixture and at least one web that extends at an angle unequal to 90° to the at least one attachment fixture. The at least one web that extends at an angle unequal to 90° to the at least one attachment fixture can be provided at an end area of the elastically deformable structure. At least one web that extends at an angle unequal to 90° to the at least one attachment fixture can further be provided at each end area of the elastically deformable structure. The angle of the at least one web at an end area can differ from the angle of the at least one web at the respectively other end area of the elastically deformable structure. With the at least one web that extends at an angle unequal to 90° to the at least one attachment fixture it can be ensured that the dock bumper or the elastically deformable structure is returned to the starting position following the impact of a vehicle. The at least one web or the webs that extends or extend at an angle unequal to 90° to the attachment fixture can generate an increased reset force that can reset the elastically deformable structure to its starting position.

The elastically deformable structure can have at least one recess. The at least one recess can be located in a central area of the elastically deformable structure. The at least one recess can be formed in the elastically deformable structure so that the at least one recess extends between several webs of the elastically deformable structure. Due to the at least one recess, the elastically deformable structure can have shorter webs and longer webs. The shorter webs can have an extension that is smaller than or equal to half of the extension of the longer webs. Due to the at least one recess, the weight of the dock bumper can be reduced. Furthermore, it can be achieved due to the least one recess that the at least one dock bumper has a more uniform stiffness over its entire cross section.

Exemplary embodiments of a dock bumper according to the present invention are described below by means of the enclosed figures. There is depicted:

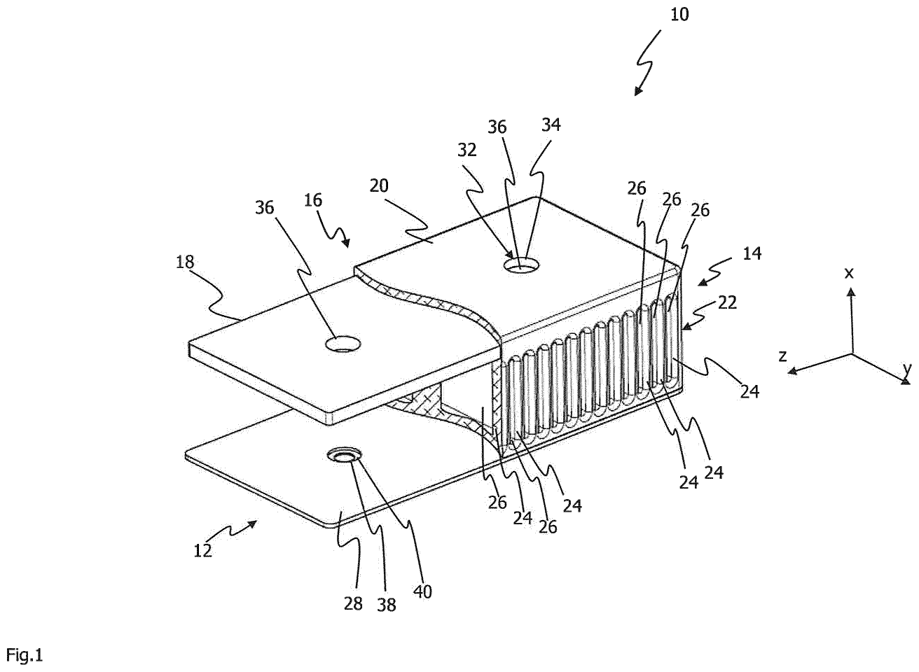

FIG. 1 a view in perspective, partly broken open, of a dock bumper according to a first embodiment of the invention;

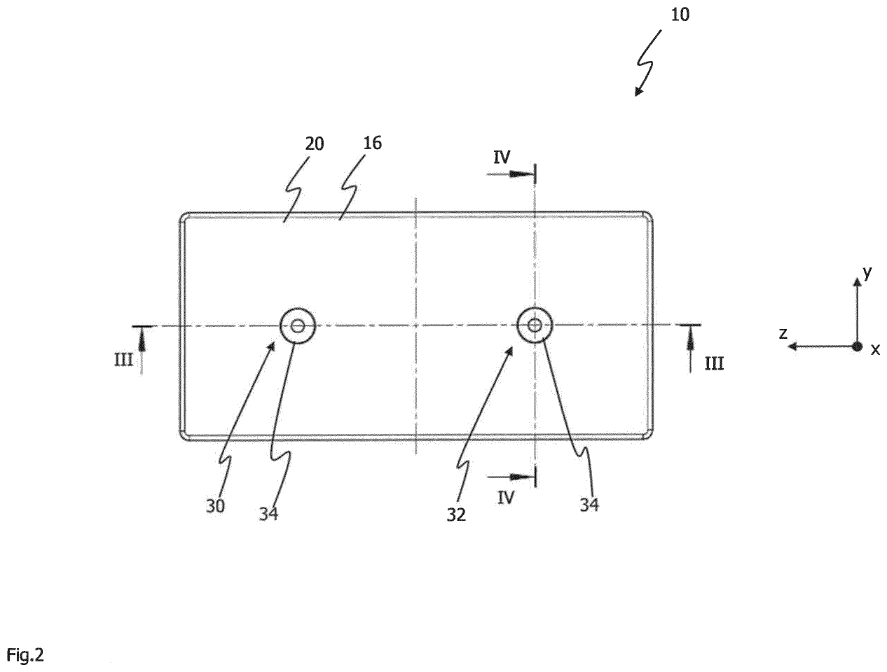

FIG. 2 a plan view of the dock bumper according to the first embodiment of the invention;

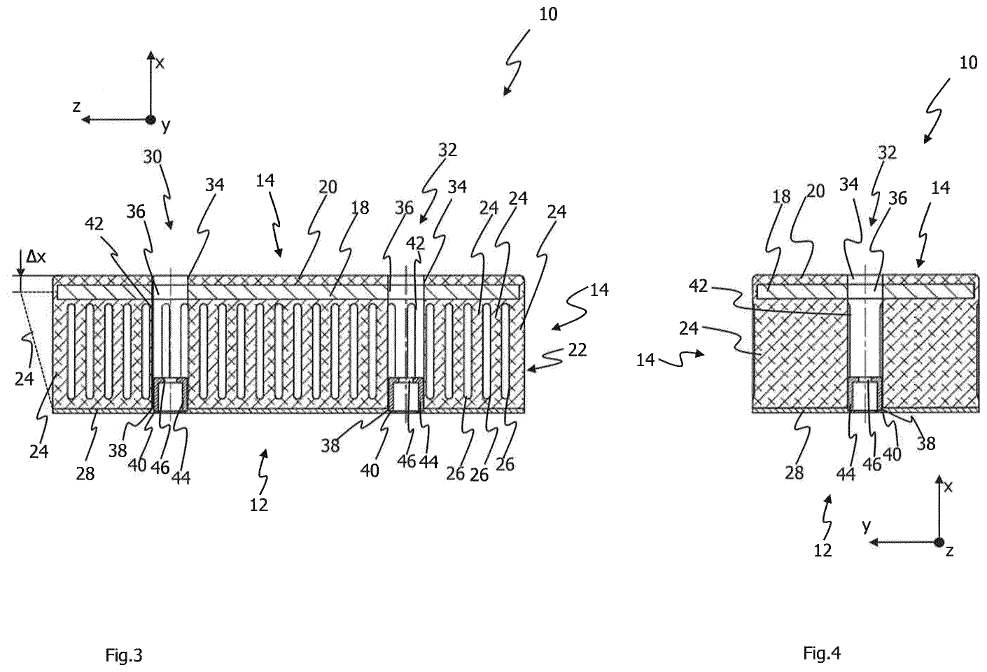

FIG. 3 a sectional view along the section line III-III in FIG. 2;

FIG. 4 a sectional view along the section line IV-IV in FIG. 2;

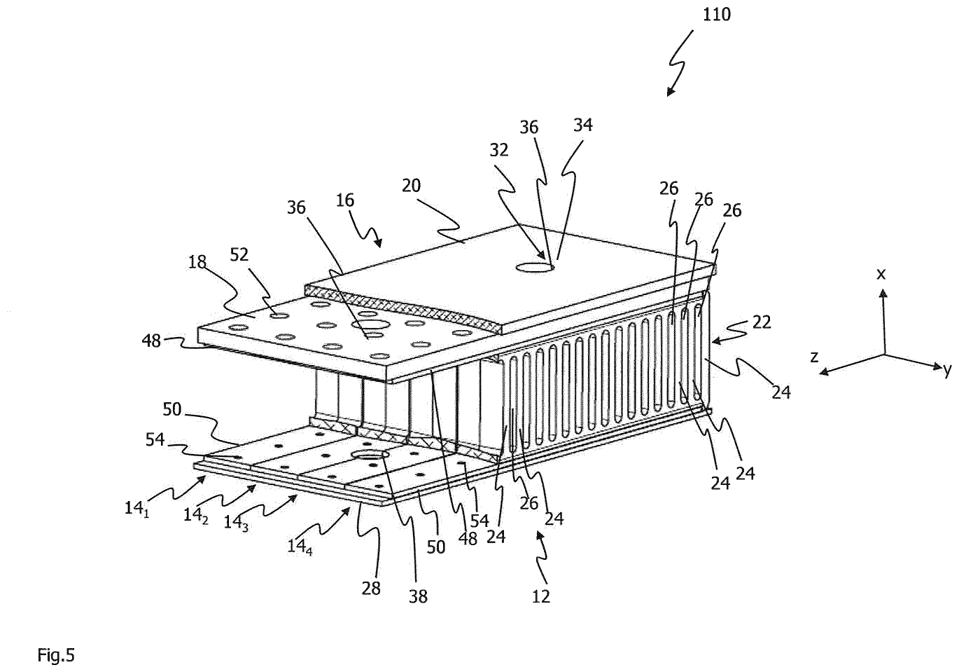

FIG. 5 a view in perspective, partly broken open, of a dock bumper according to a second embodiment of the invention;

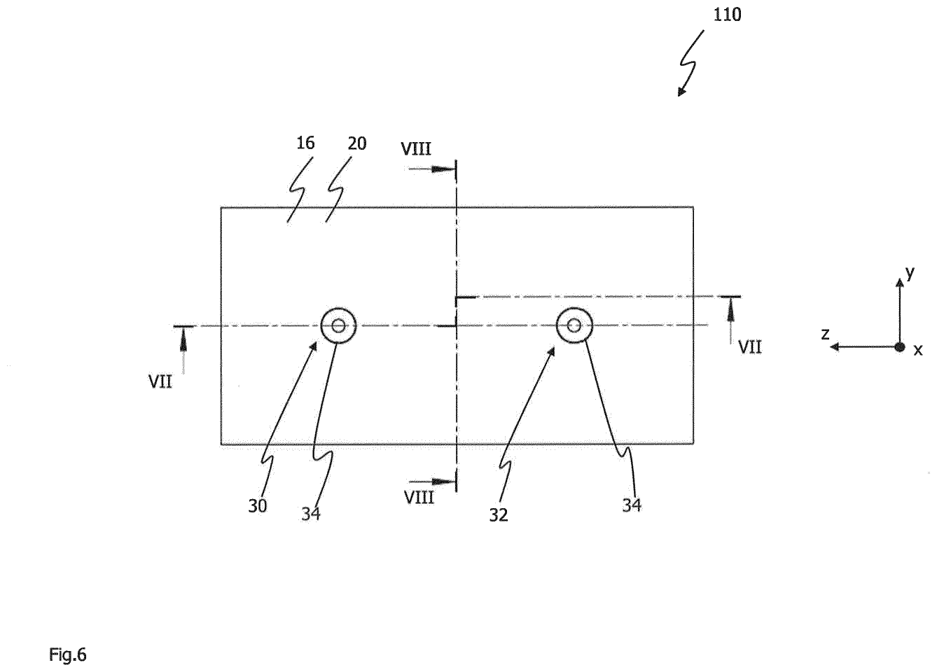

FIG. 6 a plan view of the dock bumper according to the second embodiment of the invention;

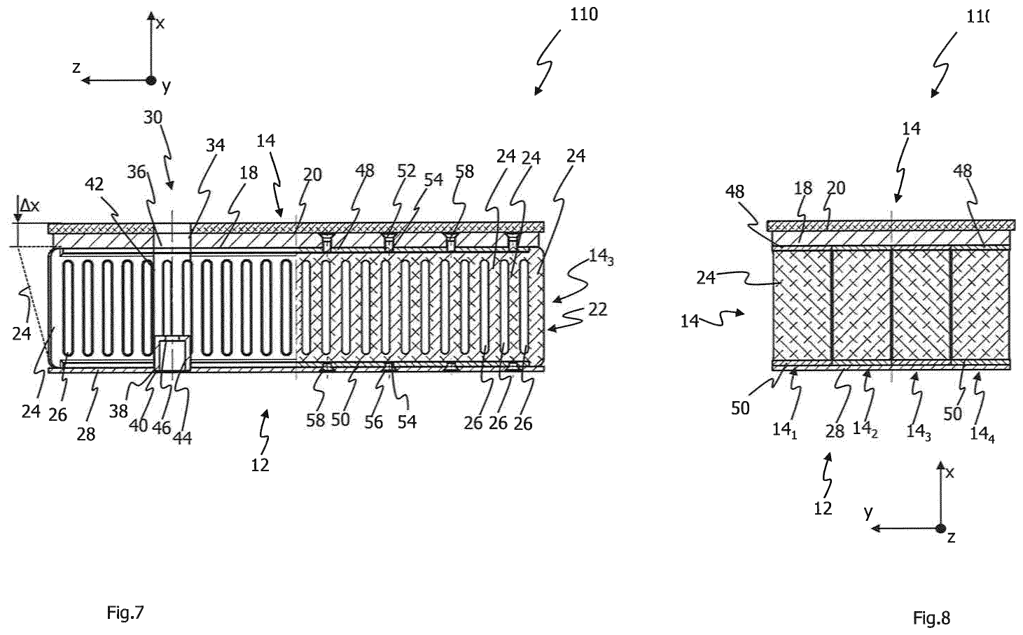

FIG. 7 a sectional view along the section line VII-VII in FIG. 6;

FIG. 8 a sectional view along the section line VIII-VIII in FIG. 6;

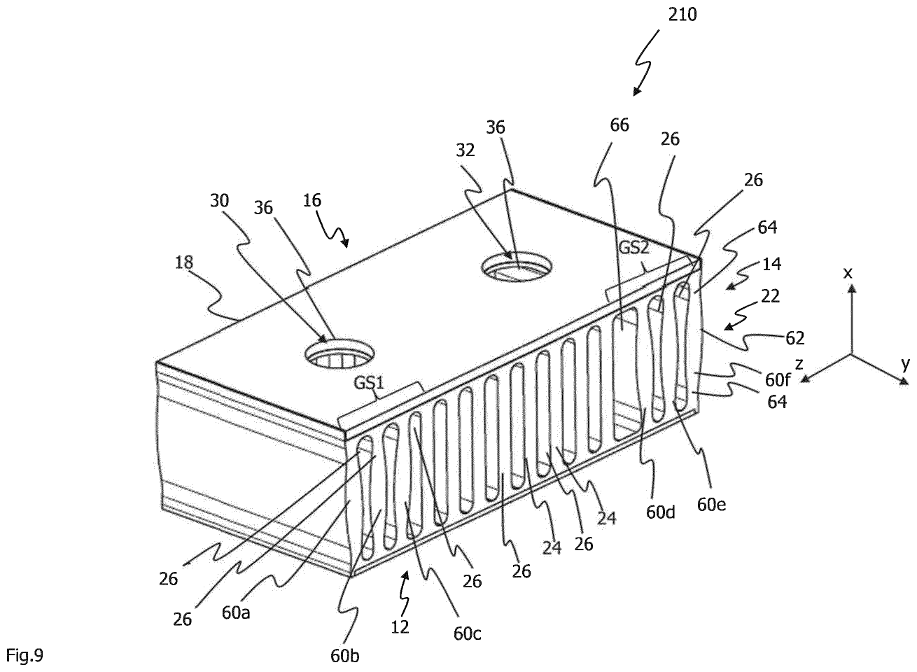

FIG. 9 a view in perspective of a dock bumper according to a third embodiment of the invention;

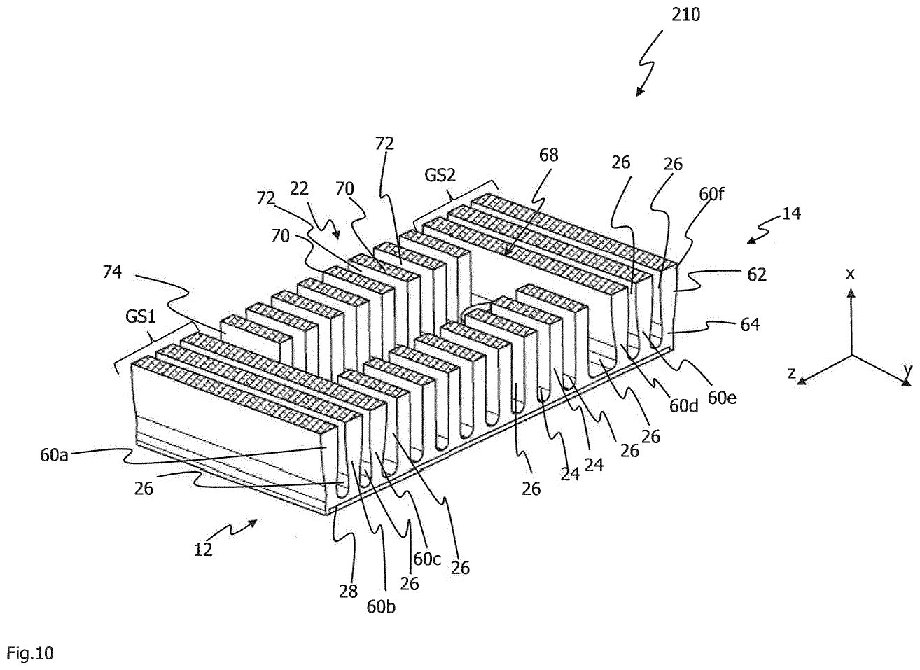

FIG. 10 a sectional view in perspective of the dock bumper according to the third embodiment of the invention;

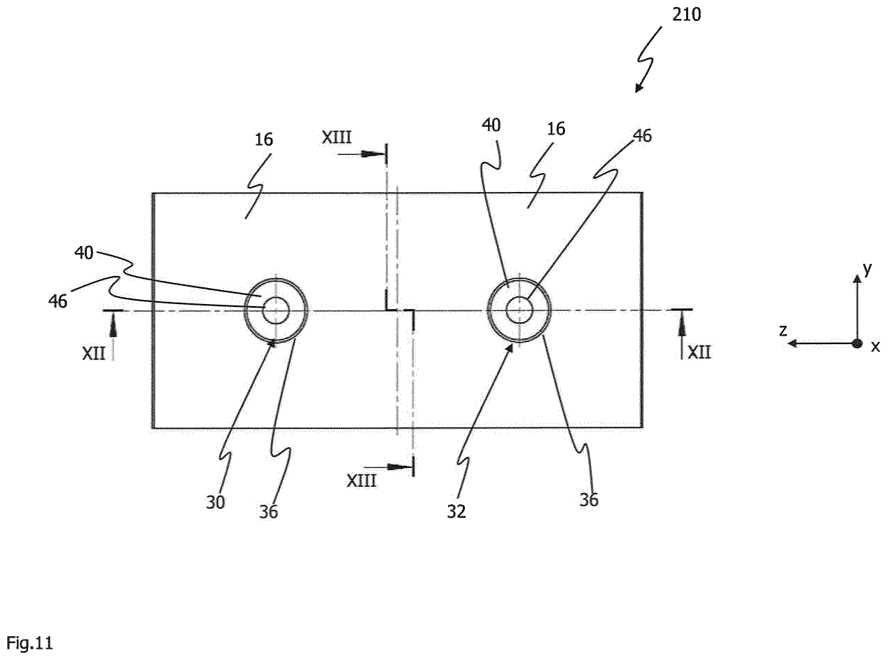

FIG. 11 a plan view of the dock bumper according to the third embodiment of the invention;

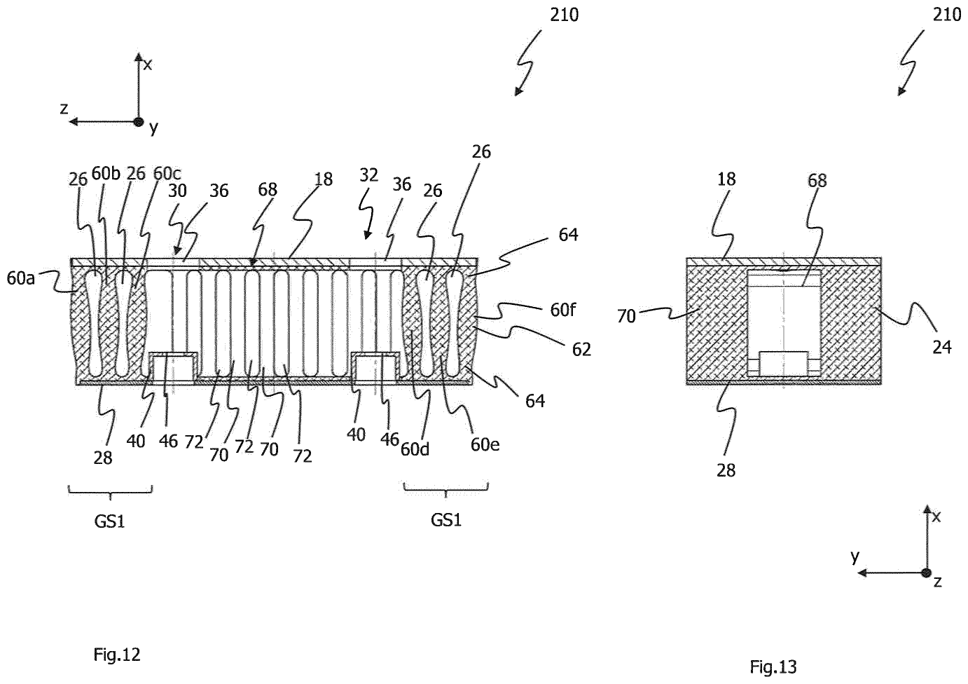

FIG. 12 a sectional view along the section line XII-XII in FIG. 11;

FIG. 13 a sectional view along the section line XIII-XIII in FIG. 11:

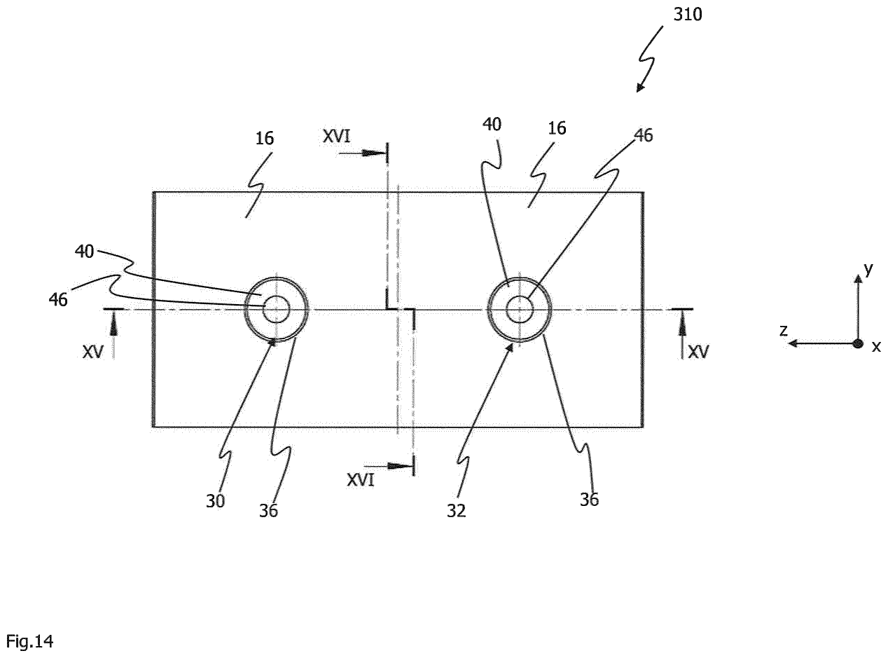

FIG. 14 a plan view of a dock bumper according to an implementation variant of the third embodiment of the invention;

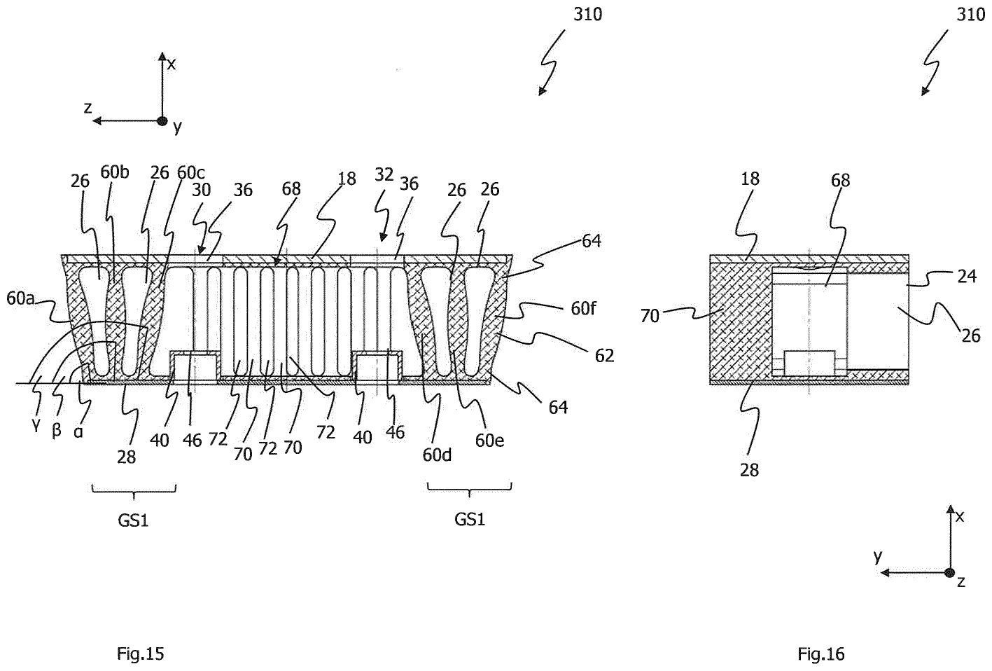

FIG. 15 a sectional view along the section line XV-XV in FIG. 14; and

FIG. 16 a sectional view along the section line XVI-XVI in FIG. 14.

FIG. 1 shows a view in perspective, partly broken open, of a dock bumper 10. The dock bumper 10 has an attachment fixture 12, an elastic body 14 and an impact fixture 16. The elastic body 14 extends between the attachment fixture 12 and the impact fixture 16. The attachment fixture 12 serves to attach the dock bumper 10 to a building in the area of a loading ramp (not shown).

The impact fixture 16 is formed by an impact plate 18 and an elastic coating 20, which extends along the impact plate 18. The impact plate 18 can be a metal plate, which is manufactured from aluminium or an aluminium alloy, for example. The elastic coating 20 can be adhesively bonded to the metal plate 18. The elastic coating 20 is executed in one piece with the elastic body 14. The impact plate 18 of the impact fixture 16 is thus completely embedded in the elastic material of the elastic coating 20 and the elastic body 14. The elastic coating 20 and the elastic body 14 can be manufactured from rubber, for example, such as e.g. an elastomer. The elastic coating 20 and the elastic body 14 can further be manufactured from a thermoplastic elastomer or a thermoplastic polyurethane. It is also conceivable to use another plastic for the elastic coating 20 and/or the elastic body 14. The elastic coating 20 comes into direct contact with an impacting vehicle and transmits the impact forces or pressing forces to the impact plate 18, which transmits the impact forces or pressing forces in turn to the elastic body 14.

The elastic body 14 has an elastically deformable structure 22, which can absorb relative movements between the impact fixture 16 and the attachment fixture 12. The elastically deformable structure 22 can absorb a relative movement of the impact fixture 16 relative to the attachment fixture 12 fixedly mounted on the building in the x-, y- and z-direction. In the event of an elastic deformation of the elastically deformable structure 22 in the x-direction, the attachment fixture 12 and the impact fixture 16 are moved towards one another. A relative movement in the x-direction takes place when a vehicle drives against the dock bumper 10. In the mounted state of the dock bumper 10 on a building in the area of a loading ramp, the x-direction entered in the figures corresponds to the horizontal direction. Furthermore, the impact fixture 16 can be deflected elastically in the z-direction with elastic deformation of the elastically deformable structure 22. Due to the elastic deflectability in the z-direction, the impact fixture 16 can follow vertical movements of the vehicle that occur, for example, during loading and unloading of the vehicle or during level adjustment of the vehicle.

The elastically deformable structure 22 has a plurality of webs 24. The webs 24 are formed by recesses 26 in the elastic body 14. For reasons of clarity only individual webs 24 and individual recesses 26 are provided with reference signs in FIG. 1. The webs 24 and recesses 26 extend in the x-direction in the elastic body 14 in the area between the attachment fixture 12 and the impact fixture 16. The recesses 26 extend completely through the elastic body 14.

The attachment fixture 12 has an attachment plate 28, which is preferably manufactured from a metal. The elastic body 14 can be adhesively bonded to the attachment plate 28. The dock bumper 10 further has attachment openings 30 and 32, which extend through all parts of the dock bumper 10. An opening 34 is formed accordingly in the elastic coating 20. The impact plate 18 of the impact fixture 16 has the openings 36. In the attachment plate 28 there is formed the opening 38, which has a step 40.

FIG. 2 shows a plan view of the dock bumper 10. The impact fixture 16 with its elastic coating 20 is recognisable in FIG. 2. The elastic coating 20 has an opening 34, which is part of the attachment openings 30, 32. The attachment openings 30 and 32 extend completely through the dock bumper 10.

FIG. 3 shows a sectional view along the section line III-III in FIG. 2. The recesses 26 that form the webs 24 are formed in the elastic body 14. The webs 24 and the recesses 26 extend completely through the elastic body 14. A layer of the elastic material is retained between the recesses 26 and the plates 18, 28, so that the recesses 26 do not reach directly up to the plates 18, 28. In the unloaded state the webs 24 extend perpendicular to the impact plate 18 and the attachment plate 28.

The attachment openings 30, 32 extend completely through the dock bumper 10. The attachment openings 30, 32 are composed of the openings 34, 36, 38 and 42 of the elastic coating 20, the impact plate 18, the attachment plate 28 and the elastic body 14. In the attachment openings 30, 32 there are provided attachment bushes 44. The attachment bushes 44 rest with their end faces on the step 40 of the openings 38 in the attachment plate 28. The attachment bush 44 has a tubular section and a section extending in a radial direction. In the section extending in a radial direction there are formed openings 46, through which an attachment means such as a screw, not shown, can be led. The attachment means can be supported with its head on the radial section of the attachment bush 44 so as to be able to support the necessary clamping forces for attaching the dock bumper to a building in the area of the loading ramp (not shown).

In the event of a relative movement in the z-direction of the impact fixture 16 relative to the attachment fixture 12 fixedly attached to a building, the webs 24 can be elastically deformed. As depicted schematically in FIG. 3, the webs 24 are deflected elastically in a relative movement in the z-direction, i.e. in the event of loads in the z-direction. The webs 24 then extend obliquely to the attachment fixture 12, wherein the positions of the ends of the webs 24 on the attachment fixture 12 remain substantially unchanged compared with the unloaded state. The positions of the ends on the impact fixture 16 change due to the deflection of the impact fixture 16 in the z-direction and also in the x-direction. Due to the deflection of the impact fixture 16 and due to the resultant inclined position of the webs 24, the extension of the dock bumper 10 in the x-direction is accordingly reduced. This reduction of the extension of the dock bumper 10 is depicted schematically in FIG. 3. The extension of the dock bumper 10 is reduced in the x-direction compared with the unloaded state of the dock bumper 10 shown in FIG. 3 by the amount Δx. Due to this reduction in the extension of the dock bumper 10, the static friction between the impact fixture 16 and in particular the elastic coating 20 and the vehicle pressed onto it can be reduced, so that the elastic coating 20 and the vehicle can slide off one another in the event of large relative movements in the z-direction. It can be prevented thereby that the elastic structure 22 becomes overloaded in the event of excessive relative movements of the vehicle in a vertical direction, such as would be the case, for example, in the case of overextension of the webs 24. In other words, by reducing the extension of the dock bumper 10 or the extension of the elastic body 14 in the x-direction, the elastic deformation of the elastically deformable structure 22 can be limited following a predetermined path in the z-direction.

FIG. 4 shows a sectional view along the section line IV-IV in FIG. 2. FIG. 4 depicts a sectional view through a web 24 and the attachment opening 32. The webs 24 extend over the entire width of the dock bumper 10.

The elastic body 14 is bonded to the impact plate 18 of the impact fixture 16 and the attachment plate 28 of the attachment fixture 12 by a material bond. From an overall view of FIGS. 3 and 4 it becomes clear that the metal plate 18 of the impact fixture 16 is embedded completely in the elastic material of the elastic coating 20 and of the elastic body 14. Since the plates 18, 28 are adhesively bonded to the elastic body 14, the dock bumper 10 forms a compact unit that can be handled as one part.

FIG. 5 shows a perspective view, partly broken open, of a dock bumper 110. The dock bumper 110 has an attachment fixture 12, an elastic body 14 and an impact fixture 16. The elastic body 14 is composed of four elastic body segments 14₁, 14₂, 14₃, 14₄. The elastic body segments 14₁, 14₂, 14₃, 14₄ each have two plates 48, 50, which are adhesively bonded to the respective elastic body segment 14₁, 14₂, 14₃, 14₄. The plates 48 and 50 can be screwed to the impact plate 18 of the impact fixture 16 and the attachment plate 28 of the attachment fixture 12. Openings 52 are provided for this in the impact plate 18 of the impact fixture 16. Such openings are also formed in the attachment plate 28 of the attachment fixture 12, but are not recognisable in FIG. 5. The plates 50 have openings 54 which are used for connection to the attachment plate 28. In the x-direction the plates 48 and 50 form the completion of the elastic body segments 14₁, 14₂, 14₃, 14₄. The body segments 14₁, 14₂, 14₃, 14₄ are joined to one another via the impact fixture 16 and the attachment fixture 12, i.e. the plates 18, 20 join the elastic body segments 14₁, 14₂, 14₃, 14₄ to one another.

FIG. 6 shows a plan view of the dock bumper 110. In FIG. 6 the impact fixture 16 is recognisable with its elastic coating 20. The attachment openings 30 and 32 extend through the dock bumper 110.

FIG. 7 shows a sectional view along the section line VII-VII in FIG. 6. The section line VII-VII runs initially between the body segments 14₂ and 14₃ before it runs into the body segment 14₃ (see FIG. 5). This is recognisable in particular due to the fact that the elastic body segment 14₃ in FIG. 7 is depicted uncut on the left-hand side, whereas on the right-hand side the elastic body segment 14₃ is depicted with its plates 48 and 50 in section.

The plates 48 and 50 of the elastic body segment 14₃ are connected to the impact plate 18 of the impact fixture 16 and to the attachment plate 28 of the attachment fixture 12. In the impact plate 18 there are formed the openings 52, the positions of which are coordinated to positions of the openings 54 in the plate 48. The plates 18 and 48 can be joined to one another via attachment means 58 that extend through the openings 52 and 54. In the attachment plate 28 of the attachment fixture 12 there are also formed openings 56, the positions of which are coordinated to positions of the openings 54 in the plate 50. The plates 28 and 50 can also be joined to one another via attachment means 58 that extend through the openings 54 and 56.

The elastic coating 20 of the impact fixture 16 extends along the surface of the impact plate 18 facing away from the elastic body segment 14₃. The impact plate 18 is not completely embedded in an elastic material. The impact plate 18 is only coated with the elastic coating 20 when the impact plate 18 has been joined via the attachment means 58 to the body segments, of which only the body segment 14₃ is shown in FIG. 7.

FIG. 8 shows a sectional view along the section line VIII-VIII in FIG. 6. Shown in FIG. 8 are the body segments 14₁, 14₂, 14₃, 14₄, the plates 48 and 50 of which abut the impact plate 18 of the impact fixture 16 and the attachment plate 28 of the attachment fixture 12. The elastic body segments 14₁, 14₂, 14₃, 14₄ thus create a connection between the attachment fixture 12 and the impact fixture 16 in the x-direction. The body segments 14₁, 14₂, 14₃, 14₄ are joined to one another via the plates 18 and 28 of the impact fixture 16 and the attachment fixture 12.

The elastic body segments 14₁, 14₂, 14₃, 14₄ are adhesively bonded to the plates 48 and 50. Following this the plates 48 and 50 of the elastic body segments 14₁, 14₂, 14₃, 14₄ are connected to the impact plate 18 of the impact fixture 16 and the attachment plate 28 of the attachment fixture 12. To complete the assembly of the dock bumper 110, the impact plate 18 is coated with the elastic coating 20, due to which the openings 52 and the attachment means 58 are concealed.

FIG. 9 shows a view of a dock bumper 210 in perspective. The dock bumper 210 has an attachment fixture 12, an elastic body 14 and an impact fixture 16. The elastic body 14 extends between the attachment fixture 12 and the impact fixture 16.

The impact fixture 16 is formed by an impact plate 18. The impact plate 18 can be a metal plate, which is manufactured from aluminium or an aluminium alloy, for example. The impact plate 18 is adhesively bonded to the elastic body 14 by its side face facing the attachment fixture 12.

The elastic body 14 has an elastically deformable structure 22, which can absorb relative movements between the impact fixture 16 and the attachment fixture 12.

The elastically deformable structure 22 has a plurality of webs 24 and webs 60 with a thickening 62. Recesses 26 are formed in the elastic body 14 between the webs 24, 60. The webs 60 are arranged respectively in two groups of three GS1 and GS2. Group GS1 comprises the webs 60a, 60b, 60c. Group GS2 comprises the webs 60d, 60e, 60f. The webs 24, 60a, 60b, 60c, 60d, 60e, 60f and the recesses 26 extend in the x- and y-direction in the elastic body 14.

The webs 60a, 60b, 60c, 60d, 60e, 60f have the thickening 62. The thickening 62 is formed in the x-direction in a central area of the webs 60. At their ends 64 the webs 60a, 60b, 60c, 60d, 60e, 60f have a smaller cross section than in the area of the thickening 62. The thinner ends 64 of the webs 60a, 60b, 60c, 60d, 60e, 60f form an articulation, so that the webs 60a, 60b, 60c, 60d, 60e, 60f can be deflected as a whole in the area of their ends 64 in the event of loading. The thickening 62 of the webs 60a, 60b, 60c, 60d, 60e, 60f stiffens the central area of the webs 60a, 60b, 60c, 60d, 60e, 60f in order to prevent bending of the webs 60a, 60b, 60c, 60d, 60e, 60f in this area. The webs 60a, 60b, 60c, 60d, 60e, 60f are provided in the z-direction at the end areas of the elastically deformable structure 22 or of the dock bumper 210. In other words, one of the groups of three GS1 and GS2 is formed respectively at one of the end areas of the dock bumper 210. A number of webs 24 that have no thickening 62 are arranged in the z-direction between the groups GS1 and GS2. At the right-hand end (in the z-direction) of the dock bumper in FIG. 9 a larger recess 66 is recognisable between the web 60d and the web 24.

The attachment fixture 12 has an attachment plate 28. The elastic body 14 can be adhesively bonded to the attachment plate 28. The dock bumper 10 further has attachment openings 30 and 32, which extend through all parts of the dock bumper 10. The impact plate 18 has openings 36, which form a section of the attachment openings 30 and 32.

FIG. 10 shows a sectional view in perspective of the dock bumper 210. The section extends through the elastically deformable structure 22. The webs 60a, 60b, 60c, 60d, 60e, 60f having a thickening 62 are provided in the z-direction at the end areas of the elastically deformable structure 22 or of the dock bumper 210. The webs 60a, 60b, 60c, 60d, 60e, 60f extend over the entire extension of the dock bumper 210 in the y-direction.

The elastically deformable structure 22 of the dock bumper 210 has a recess 68. The recess 68 is formed in a central area of the elastically deformable structure 22. The recess 68 extends in the z-direction between the groups GS1 and GS2.

Apart from the webs 24 and 60a, 60b, 60c, 60d, 60e, 60f, the elastically deformable structure 22 has webs 70, which are formed by recesses 72 in the elastic body 14. The webs 24 and 70 are separated from one another by the recess 68. The recess 68 extends in the y-direction between the webs 24 and 70. The webs 24 and 70 are formed in the elastic body 14 offset to one another in the z-direction. Due to the offset of the webs 24 and 70 in the z-direction, the larger recess 66 is formed between the web 60d and the web 24 and the larger recess 74 is formed between the web 70 and the web 60c. Due to the recess 68 the webs 24 and 70 are formed shorter in the y-direction than the webs 60 with the thickening 62.

FIG. 11 shows a plan view of the dock bumper 210. The impact fixture 16 with its impact plate 18 is recognisable in FIG. 11. The impact plate 18 has the openings 36. The attachment openings 30 and 32 extend completely through the dock bumper 210.

FIG. 12 shows a sectional view along the section line XII-XII in FIG. 11. The section line runs through the recess 68 (see FIG. 10). In the sectional view according to FIG. 11, the recesses 26 and 72 in the elastic body 14, which form the webs 60a, 60b, 60c, 60d, 60e, 60f and 70, are recognisable. Also recognisable between the web 60c and the next web of the webs 70 in the z-direction is the larger recess 74.

The webs 60a, 60b, 60c, 60d, 60e, 60f have the thickening 62 in a central area in the x-direction. The webs 60a, 60b, 60c, 60d, 60e, 60f are arranged respectively in groups GS1 and GS2 of three webs 60a, 60b, 60c and 60d, 60e, 60f. Groups GS1 and GS2 are provided in the z-direction at the end areas of the dock bumper 210 or of the elastically deformable structure 22. Provided between the two groups of three GS1 and GS2 are webs 24 that have no thickening. Since the section line XII-XII extends through the recess 68, the webs 24 in FIG. 12 are not shown in section.

In the area of the recesses 26, 72, 74 and the recess 68, a coating of the elastic material is retained on the plates 18, 28, so that the recesses 26, 72, 74 and the recess 68 do not reach directly up to the plates 18, 28.

In the unloaded state the webs 24 extend perpendicular to the impact plate 18 and the attachment plate 28. In the unloaded state each web 60a, 60b, 60c, 60d, 60e, 60f can extend at a predetermined angle to the attachment plate 28. The predetermined angle can be unequal to 90°. The angles at which the individual webs 60a, 60b, 60c, 60d, 60e, 60f extend to the attachment plate 28 may vary. Expressed otherwise, the webs 60a, 60b, 60c, 60d, 60e, 60f of a group GS1 or GS2 can extend at different angles to the attachment plate 12. It can be ensured by this that the elastically deformable structure 22, following a deflection due to the impact of a vehicle, for example, is reset to its starting position. With the groups GS1 and GS2 a further increased reset force can thus be generated compared with webs oriented exclusively at an angle of 90°, which force returns the elastically deformable structure 12 to its starting position.

The attachment openings 30, 32 extend completely through the dock bumper 10. The attachment openings 30, 32 are composed of the openings 36 of the impact plate 18, a section of the recess 68 and the openings 38 of the attachment plate 28. In the attachment openings 30, 32 there are provided attachment bushes 44. The attachment bushes 44 rest with their end faces on the attachment plate 28 or on the edge of the openings 38 of the attachment plate 28. The attachment bush 44 has a tubular section and a section extending in a radial direction. In the section extending in a radial direction there are formed openings 46, through which an attachment means such as a screw, not shown, can be led. The attachment means can be supported with its head on the radial section of the attachment bush 44 in order to be able to support the necessary clamping forces for attaching the dock bumper to a building in the area of the loading ramp (not shown).

FIG. 13 shows a sectional view along the section line XIII-XIII in FIG. 11. In FIG. 13 the impact plate 18, the elastic body 14 and the attachment plate 28 are shown. The elastic body 14 extends between the impact plate 18 and the attachment plate 28. The elastically deformable structure 22 of the elastic body 14 has the recess 68 in its central area. The recess 68 extends between the webs 24 and 70.

FIGS. 14 to 16 show a dock bumper 310, which represents a variant of the dock bumper 210 according to FIGS. 9 to 13. FIG. 15 shows a sectional view along the section line XV-XV in FIG. 14. FIG. 16 shows a sectional view along the section line XVI-XVI in FIG. 14. The substantial difference between the dock bumper 210 according to FIGS. 9 to 13 and the dock bumper 310 according to FIGS. 14 to 16 is constituted by the webs 60a, 60b, 60c, 60d, 60e, 60f, which extend at a larger angle to the attachment plate 28.

The webs 60 have the thickening 62. Each of the webs 60a, 60b, 60c, 60d, 60e, 60f of the two groups GS1 and GS2 extends in the resting state of the dock bumper 310 at a predetermined angle to the impact plate 28. The webs 60 of each of the groups GS1 and GS2 extend at such an angle to the impact plate 28 that the spacing of the webs 60a, 60b, 60c of group GS1 and the webs 60d, 60e, 60f of group GS2 from one another increases in the x-direction. The webs 60b and 60e can extend substantially perpendicularly or at an angle of 90° to the impact plate 28. Some of the webs 60a, 60c, 60d and 60f can have an angle to the impact plate 28 that is unequal to 90°. By way of example, the angles α, β, γ are entered in FIG. 15 for the webs 60a, 60c and 60d. The webs 60a, 60b and 60c extend at the angles α, β, γ to the attachment plate 28. The same applies to the webs 60d, 60e, 60f, which can extend at the same or similar angles to the attachment plate 28. Those of the webs 60a, 60b, 60c, 60d, 60e, 60f that extend at an angle unequal to 90° to the attachment plate 28 can extend at an angle of between 30° and 89° or between 91° and 150° to the attachment plate 28. In particular, the angle can be between 80° and 89° or between 91° and 100° to the attachment plate 28. In the resting state of the dock bumper 310 the webs 60a and 60d can run substantially parallel to one another. The same applies to the webs 60b and 60e and to the webs 60c and 60f, which likewise run parallel to one another in the resting state or in the unloaded state. It can be ensured by the webs 60a, 60b, 60c and 60d, 60e, 60f of the groups GS1 and GS2, which run partially at an angle unequal to 90° to the attachment plate 28, that the elastically deformable structure 22 or the dock bumper 310 is reset to its starting position following a deflection due to the impact of a vehicle, for example. The groups GS1 and GS2 can thus generate a reset force that returns the dock bumper 310 to its starting position.

FIG. 16 shows the impact plate 18, the elastic body 14 and the attachment plate 28. The elastic body 14 extends between the impact plate 18 and the attachment plate 28. The elastically deformable structure 22 of the elastic body 14 has the recess 68 in its central area. The recess 68 extends between the webs 24 and 70. The recess 26 which is located before the web 24 is also recognisable in FIG. 16.

The attachment and function of the dock bumper 10, 110, 210, 310 is explained below:

The dock bumper 10, 110, 210, 310 is mounted via the attachment fixture 12 on a building in the area of a loading ramp. To do this, screws as attachment means (not shown) are introduced into the attachment openings 30, 32. The screws extend through the opening 46 of the attachment bushes 44 and rest with their head on the radial section of the attachment bushes 44. The screws can be tightened via the attachment openings 30, 32 using a spanner or hexagon key to generate the necessary clamping forces via the attachment bushes 44 to attach the dock bumper 10, 110, 210, 310 to the loading ramp.

If a vehicle drives against the dock bumper 10, 110, 210, 310 and comes into contact with the impact fixture 16, a relative movement takes place between the impact fixture 16 and the attachment fixture 12 mounted fixedly on the building. Due to the impact fixture 16 with the impact plate 18, the impacting section of the vehicle cannot locally penetrate the dock bumper 10, 110, 210, 310. The impact plate 18 conducts the impact forces or pressing forces into the elastic body 14 and distributes the impact forces over all webs 24, 60, 70 of the elastically deformable structure 22 of the elastic body 14. The webs 24 are deformed elastically in the x-direction by the contact with the vehicle, i.e. the impact fixture 16 is displaced in the direction of the attachment fixture 12. Due to the introduction of the impact forces or pressing forces via the impact plate 18 into the webs 24, 60, 70 of the elastically deformable structure 22, the dock bumper 10, 110, 210 310 has a relatively high stiffness in the x-direction, due to which the dock bumper 10, 110, 210, 310 can absorb relatively high impact forces in the x-direction. The dock bumper has a relatively high stiffness in the y-direction also due to the elastically deformable structure 22 and the impact fixture 16.

In the z-direction the dock bumper 10 is relatively soft on account of the webs 14 deflectable via the impact fixture 16. In the state mounted on the building, the z-direction entered in the drawings corresponds to the vertical direction. If a vehicle is in contact with the dock bumper 10, 110, 210, 310, movements of the vehicle can take place in the z-direction, for example due to the adjustment of the height of the truck bed of the vehicle to the level of the loading ramp or by compression of the suspension of the vehicle. The dock bumper 10, 110, 210, 310 can follow such movements in the z-direction with the impact fixture 16 with elastic deformation of the elastically deformable structure 22 over a predetermined path in the z-direction. The impact fixture 16 is deflected with elastic deformation of the elastically deformable structure 22 in the z-direction relative to the stationary attachment fixture 12. Here the webs 24 of the elastically deformable structure 22 are deflected, wherein they extend in the deflected state obliquely to the attachment fixture 12 (see FIGS. 3 and 7). Due to the inclined position of the webs 24, 60, 70, the extension of the dock bumper 10, 110, 210, 310 in the x-direction decreases, whereby the impact forces acting on the dock bumper 10, 110 in the x-direction decrease.

Due to the reduction in the extension of the dock bumper 10, 110, 210, 310 in the x-direction, the static friction between the elastic coating 20 and the impact plate 18 of the impact fixture 16, and the section of the vehicle in contact with the dock bumper 10, 110, 210, 310 is reduced. Due to the reduced static friction the elastic coating 20 of the impact fixture 16 and the section of the vehicle can slide off one another without the dock bumper 10, 110, 210 310 being damaged. The elastic deformation of the elastically deformable structure 22 can be limited after a predetermined path in the z-direction due to the reduction of the extension of the dock bumper 10, 110, 210, 310 in the x-direction. Damage to the dock bumper 10, 110, 210, 310 can be prevented thereby and the service life of the dock bumper 10, 110, 210, 310 increased considerably.

1. A dock bumper for attachment to a building, the dock bumper comprising:
at least one attachment fixture structured for attaching the dock bumper to the building;
at least one elastic body connected to the at least one attachment fixture; and
at least one impact fixture for transmitting the impact forces arising on impact of a vehicle to the elastic body, wherein the at least one impact fixture has at least one stiff impact plate;
wherein the at least one elastic body has an elastically deformable structure, which is structured so that the impact fixture is deflectable with elastic deformation of the elastically deformable structure relative to the attachment fixture, wherein the elastically deformable structure has a plurality of webs, which extend in the area between the stiff impact plate and the attachment fixture, and wherein the stiff impact plate and the elastically deformable structure comprise different materials.

2. The dock bumper according to claim 1, wherein the elastically deformable structure is structured so that the impact fixture is deflectable with elastic deformation relative to the attachment fixture in a direction that runs perpendicular to a plane spanned by two directions in which the elastic body absorbs relative movements of the impact fixture relative to the attachment fixture.

3. The dock bumper according to claim 1, wherein at least one of the plurality of webs is formed by at least one recess in the elastic body.

4. The dock bumper according to claim 1, wherein at least one of the plurality of webs extends perpendicular to the attachment fixture and the impact fixture.

5. The dock bumper according to claim 1, wherein the at least one impact fixture extends substantially along the entire elastically deformable structure.

6. The dock bumper according to claim 1, wherein the at least one impact fixture has an elastic coating, which extends along the impact plate.

7. The dock bumper according to claim 1, wherein the attachment fixture has at least one plate-shaped attachment element.

8. The dock bumper according to claim 1, wherein the dock bumper has at least one attachment opening, which extends through the at least one impact fixture, the at least one elastic body and the at least one attachment fixture.

9. The dock bumper according to, wherein the attachment fixture has at least one attachment bush, which is taken up in the at least one attachment opening.

10. The dock bumper according to claim 1, wherein the at least one elastic body is composed of a plurality of elastic body segments.

11. The dock bumper according to claim 10, wherein each elastic body segment has two plate-shaped elements, which are used for the connection to the impact plate and the plate-shaped attachment element.

12. The dock bumper according to claim 1, wherein the at least one elastic body comprises rubber, a thermoplastic elastomer or a thermoplastic polyurethane.

13. The dock bumper according to claim 1, wherein at least one selected from the group consisting of (1) the at least one impact plate and (2) the plate-shaped attachment element comprises metal.

14. The dock bumper according to claim 1, wherein at least one of the plurality of webs which has at least one thickening.

15. The dock bumper according to claim 14, wherein the at least one of the plurality of webs with at least one thickening is arranged at an end area of the elastically deformable structure.

16. The dock bumper according to claim 1, wherein at least one of the plurality of webs of the elastically deformable structure extends at a predetermined angle to the at least one attachment fixture.

17. The dock bumper according to claim 16, wherein the predetermined angle in the unloaded state of the dock bumper is unequal to 90°.

18. The dock bumper according to claim 1, wherein the elastically deformable structure has at least one recess.

19. The dock bumper according to claim 2, wherein at least one of the plurality of webs is formed by at least one recess in the elastic body.

20. The dock bumper according to claim 1, wherein at least one of the plurality of webs extends perpendicular to the attachment fixture and the impact fixture.
